(19) United States
(12) Patent Application Publication
(10) Pub. No.: US 2021/0317848 A1
(43) Pub. Date: Oct. 14, 2021

(54) DIGITAL PUMP AXIS CONTROL SYSTEM

(71) Applicant: MOOG ITALIANA S.R.L., Malnate (IT)

(72) Inventors: Giorgio Maria CONSONNI, Millan (IT); Riccardo Matteo PRENCIPE, Milan (IT)

(21) Appl. No.: 17/266,575

(22) PCT Filed: Aug. 8, 2019
(86) PCT No.: PCT/EP2019/071336

§ 371 Date: Feb. 6, 2021

(30) Foreign Application Priority Data
Aug. 16, 2018 (DE) 10 2018 120 001.3

(51) Int. Cl. F15B 11/17; F15B 11/16

(52) U.S. Cl. CPC F15B 11/17; F15B 11/165; F15B 11/166; F15B 2211/20576; F15B 2211/20546; F15B 2211/20561; F15B 2211/3057; F15B 2211/20515

(57) ABSTRACT

A digital pump axis control system having a circuit including an electric engine, powering first and second hydraulic machines connected in a rotationally locked manner to each other. At least one cylinder has a first chamber connected through a first pipeline to the first hydraulic machine and a second chamber of the cylinder is connected through a second pipeline to the second hydraulic machine. A first valve is arranged in the first pipeline; a second valve is arranged in the second pipeline; a third valve is arranged in a third pipeline, wherein the third pipeline connects a portion of the first pipeline between the first hydraulic machine and the first valve and a portion of the second pipeline between the second hydraulic machine and the second valve. An open tank provides hydraulic fluid to inlets of the first and second hydraulic machines. The first and second hydraulic machines are digital variable displacement pumps, each providing a positive and a negative displacement of hydraulic fluid.

The present invention relates to a digital pump system, especially to a digital pump axis control system.

Pump axis control systems are vastly known in the prior art and are mostly used to control deep drawing machines, injection moulding machines and in general pressing machines. However, their use is not limited to these types of machines and can be used for all machines in which a pump system is necessary.

One of the main problems in pump control systems and generally in electro-hydrostatic drive units is the vast amount of energy needed for a work cycle of the machine. Unfortunately, many systems require even more energy, due to a continuous energy loss in various steps of the work process.

It is therefore the aim of the following invention to provide a pump axis control system which not only at least partially reduces the energy required for a such a process, but which also manages to at least partially recover and at least partially reduce the unnecessary loss of energy during a work process.

The aim is at least partially solved by a digital pump axis control system as specified in claim 1. Various embodiments are specified in the sub claims 2 to 13. A method for using the digital pump axis control system is specified in claims 14 to 20.

According to one embodiment of the invention the digital pump axis control system is a circuit being at least partially open. The circuit comprises: an electric engine, powering a first and a second hydraulic machine, wherein the first and second hydraulic machines are connected in a rotationally locked manner to each other; at least one cylinder, having a first chamber and a second chamber, wherein the first chamber of the cylinder is connected through a first pipeline to the first hydraulic machine and the second chamber of the cylinder is connected through a second pipeline to the second hydraulic machine. According to this embodiment the system further comprises a first valve arranged in the first pipeline; a second valve arranged in the second pipeline; a third valve arranged in a third pipeline, wherein the third pipeline connects a portion of the first pipeline arranged between the first hydraulic machine and the first valve with a portion of the second pipeline arranged between the second hydraulic machine and the second valve; the embodiment further comprises an open tank providing hydraulic fluid to inlets of the first and second hydraulic machines. The digital pump system of this preferred embodiment is further characterized in that the first and second hydraulic machines are digital variable displacement pumps, each providing a positive and a negative displacement of hydraulic fluid.

According to the above embodiment, the system comprises an electric engine powering a first and a second hydraulic machine. These hydraulic machines are used to provide a displacement of hydraulic fluid through the system and according to the embodiment they are connected to each other in a rotationally locked manner, meaning that they rotate in the same direction.

The displacement of fluid provided by the hydraulic machines results in a movement of the rod in the cylinder. The cylinder has two chambers, wherein one chamber, the first one, is connected through a pipeline to the first hydraulic machine, and the second chamber is connected to the second hydraulic machine, through a second pipeline.

The terms “positive displacement” and “negative displacement” of hydraulic fluid are defined herewith as a movement of hydraulic fluid created by the hydraulic machines towards the cylinder and a movement of hydraulic fluid created by the hydraulic machines away from the cylinder. In some case it is also described as a push of hydraulic fluid from the hydraulic machines and a drawing of hydraulic fluid from the hydraulic machine, however this definition is only used when it is clear from where and into what a hydraulic machine is drawing and pushing hydraulic fluid.

Characterizing this embodiment is the fact that the first and second hydraulic machines are both digital variable displacement pump which can independently provide a positive and negative displacement, (even though they are connected in a rotationally locked manner to each other).

From now on, the terms “digital variable displacement pump” and “pump” are used in an interchangeable manner.

According to the invention, the two digital variable displacement pumps are connected in a rotationally locked manner. They can both provide positive and negative displacement of hydraulic fluid. Through different switch position of the valves in the system, it is hence possible to have various working cycles of the cylinder, i.e. rapid speed or force speed, depending on the action a tool, attached to the cylinder, needs to accomplish. The rotationally locked connection of the displacement pumps is advantageously as a force pushing one of the pumps in one direction of rotation, results in a rotation of the other pump. The electric engine is therefore an energy generator through which some of the rotational energy can be saved or at least reused. Later in the description these aspects are described more in detail.

According to a further embodiment, the digital variable displacement pumps provide independent or coordinated displacement of hydraulic fluid. These degree of freedom in the type of displacement each pump can produce independently from the other, guarantees a better adjustment of the various work cycles of the press, resulting in a better energy management.

According to a further embodiment the digital variable displacement pumps can provide different volume of hydraulic fluid and/or hydraulic fluid with different pressure. This embodiment adds an even further degree of freedom, guaranteeing that even though the pumps are locked rotationally they can each work independently from each other.

The two digital variable displacement pumps are independent from each other and therefore manage to supply different volume and different pressure of hydraulic fluid in different directions, notwithstanding the fact that they are connect in a rotationally locked manner with each other.

With the term “same displacement” it is therefore meant that the pumps both create a positive or a negative displacement of hydraulic fluid. The volume of hydraulic fluid that is displaced by each pump is however not necessarily the same, and each pump can be singularly set to displace a certain volume of hydraulic fluid per second.

Preferred types of digital variable displacement pumps according to a further embodiment are axial piston pumps, bent axis pumps, variable displacement vane pumps, radial piston pumps or similar types of pump.

The digital variable displacement pumps can work in various way. Usually the output of a variable displacement pump can be changed by altering the geometry of the displacement chamber, and more specifically in piston pumps by varying the angle of the swash plate through tilting.

In variable displacement vane pumps for example the gear is offset and the cogs aren't fixed, but rather extend and retract as the gear turns, allowing the pump to increase the pressure of the fluid by compacting it as it pushes the fluid through.

According to a further embodiment the cylinder is a differential cylinder having a rod chamber and a piston chamber. This type of cylinder is especially suited for a pressing system; however, the system can work with whatever type of cylinder is required i.e. a symmetric cylinder, a synchronized cylinder, telescopic cylinder and similar.

A differential cylinder is defined as being a cylinder which has at least two different chambers with different volumes. The rod chamber is defined as the chamber in which the rod is attached to the piston while the piston chamber is the chamber in which the piston's face is faced. Alternatively, a rod can be attached to the piston also on the piston side, however it needs to have a smaller diameter than the rod on the rod side in order to define the cylinder as a differential cylinder. The tool for pressing is usually attached to the bigger rod.

The cylinder, independent from which type of cylinder it is, is, according to a further embodiment, operable in rapid and/or force speed mode.

In a usual work cycle of the cylinder there are 4 main phases which have to be considered. Firstly, the cylinder, needs to be moved quickly towards the tool to be processed. This is called “rapid speed down” and requires relatively small amount of pressure of hydraulic fluid, but greater displacement of volume.

The second phase is the phase in which the tool is being processed. This is the phase in which most strength is required and is therefore defined as the “force speed” of the cylinder. In this phase high pressure of hydraulic fluid but little volume is required.

In the third phase a decompression occurs. The high pressure in the system required during the previous phase, needs to be reduced without causing a movement of the cylinder; this achieved through decompressing the hydraulic fluid in the system.

The fourth and final phase is the “rapid speed up” in which the cylinder is quickly pushed away from the processed tool, for example for a tool exchange.

According to a further embodiment, the first valve is situated on a first pipeline connecting the first chamber of the cylinder with the first hydraulic machine. The second valve is situated on a second pipeline connecting the second chamber of the cylinder with the second hydraulic machine. According to a further embodiment the first and the second valves are controlled 2/2-way valves having a closed state and an open state. According to even a further embodiment the first and the second valves further comprise a position monitoring device to increase the security measures of the system and guaranteeing that the valves are correctly switched.

The third valve is positioned on a third pipeline which connects the first and the second pipeline. This third valve can also be a 2/2-way valves having a closed state and an open state according to a further embodiment of the invention. Position monitoring device on the third valve can be also attached in some further embodiments.

As mentioned earlier the third pipeline connects the first pipeline to the second pipeline. It is therefore possible through switching the third valve to have both hydraulic machine work together on the same chamber of the cylinder.

According to a further embodiment a further tank is hydraulically connected with the second chamber of the cylinder through a fourth valve having an open and a closed state. The use of a tank is especially advantageous in both the rapid speed down phase and rapid speed up phase as will be explained further in detail later in the description. According to a further embodiment, and in order to reduce material cost for the system, it is possible that the further tank and the open tank are one single tank.

According to even a further embodiment a controlled pilot valve to pilot open the fourth valve is connected through a further pipeline to the fourth valve. The controlled pilot valve can be controlled in many ways, however according to an even further embodiment a pressure source is connected to the controlled pilot valve in order to control the pilot valve through pressurized hydraulic fluid coming from the pressure source. According to further embodiments the pilot valve is a controlled 2/3-way valve having a pressurized state and a depressurized state.

It is a further aim of the current invention to provide an inventive method for using one of the many embodiments of the system, as described above.

According to one embodiment of a method for using the digital pump axis control system of any of the preceding embodiments in which the further tank is not present, a downwards movement of the cylinder is achieved by switching the third valve to close, and by switching the first and second valves to open. Further the first digital variable displacement pump is switched to provide a negative displacement of hydraulic fluid, and the second digital variable displacement pump is switched to provide a positive displacement of hydraulic fluid,

By closing the third valve, according to this method, the first and second pipelines are not connected to each other, and the first pump works exclusively on the first chamber of the cylinder and the second pump exclusively on the second chamber of the cylinder.

By having the first digital variable displacement pump providing a negative displacement and the second digital variable displacement pump providing a positive displacement of hydraulic fluid, a movement of the cylinder downwards is achieved.

More specifically, fluid is being drawn by the first digital variable displacement pump from the first chamber of the cylinder into the open tank, while hydraulic fluid is being drawn from the open tank, by the second digital variable displacement pump, into the second chamber of the cylinder.

This causes a movement of the cylinder downwards as the high pressure and the high volume of fluid in the second chamber is pushing the rod of the cylinder downwards, while the fluid from the first chamber of the cylinder is released through the first pump into the open tank.

Because the high pressure in the second chamber of the cylinder is pushing the cylinder downwards, the hydraulic fluid in the first chamber needs to be released. The first valve is set to open and therefore the hydraulic fluid is being pushed from the first chamber of the cylinder through the first pipeline and through the first pump into the open tank. Therefore, advantageously, less energy is required by the first pump to generate a negative displacement from the first chamber into the open tank. The displacement of fluid from the first chamber of the cylinder causes a torque movement of the first pump and hence it generates energy. Positive in this embodiment is therefore that the energy caused by the displacement of hydraulic fluid is not being wasted but either reused for assisting the torque movement of the pump, or at least partially saved by the electric engine and reused in some other process.

According to another embodiment of the method, the upwards movement of the cylinder is achieved by switching to close the third valve, switching to open the first and second valves; switching the first digital variable displacement pump to provide a positive displacement of hydraulic fluid and switching the second digital variable displacement pump to provide a negative displacement of hydraulic fluid.

With the same but opposite reasoning of the embodiment above an upwards moment of the cylinder is achieved. Again, energy caused by the torque movement of the second pump can be reused for moving the pumps or at least saved for some further application. Energy consumption is therefore minimized.

According to even a further embodiment of the method for using the digital pump axis control system the first, second and third valve are switched open, and the first and second digital variable displacement pumps are switched to provide the same displacement of hydraulic fluid towards the second chamber of the cylinder such that a low force downwards movement of the cylinder is achieved.

Further, according to another embodiment the motor acts as an energy generator during a decompression phase of the cylinder.

In a further embodiment of a method for using a digital pump control system in those embodiments of the system in which a tank is attached to the piston chamber of the cylinder, the second valve is switched to close and the pilot valve is switched to a depressurized state while the first and third valve are switched to open. Further, the first and second digital variable displacement pumps are switched to provide the same displacement of hydraulic fluid from the first chamber of the cylinder to the open tank, such that the further tank causes a displacement of hydraulic fluid into the second chamber to compensate the volume of hydraulic fluid missing in the system.

In this embodiment, the first and the second digital variable displacement pumps are switched to provide the same displacement of fluid from the first chamber into the open tank, in order to achieve a downwards movement of the cylinder. This fluid displacement causes a state of low pressure in the second chamber. This under-pressure in the second chamber of the cylinder causes the fourth valve, which is pressure regulated to open and hydraulic fluid is displaced from the tank into the second chamber.

This method is especially advantageously, as with the two pumps displacing in the same direction a quicker movement of the cylinder is achieved, minimizing therefore the time requirements for a process cycle and consequently minimizing general costs.

As mentioned earlier in the application, the decompression phase after having processed a tool is fundamental for the appropriate and fault free use of the system.

In an even further embodiment of the method the third valve is switched to close and the pilot valve is switched to a depressurized state whereby the fourth valve is closed while the first and second valves are switched to open. This situation is similar to the embodiments were the further tank was not present in the system (as the fourth valve is closed). Further in this embodiment a decompression phase of the cylinder occurs and a displacement of hydraulic fluid from the second chamber to the open tank causes a torque movement of the second digital variable displacement pump through which the electric engine acts as an energy generator.

More specifically, due to the decompression a relaxation of hydraulic fluid both in the cylinder chambers as in the pipeline occurs. This relaxation causes a displacement of hydraulic fluid through the pipelines and through the digital variable displacement pump causing a torque movement of the pump. This torque movement can be interpreted as energy which the motor generates. This is clearly advantageous as this decompression energy would otherwise be lost energy, while through this embodiment it can be reused or at least saved by the electric engine for some other process.

Consequently, following the various work cycles of the cylinder, an embodiment in which a rapid speed upwards movement of the cylinder occurs is also described. Specifically, in a further embodiment of the method the pilot valve is switched to a pressurized state, whereby the fourth valve is opened, and the first and third valves are switched open while the second valve is switched closed. Further in this embodiment the first and second digital variable displacement pumps are switched to provide the same displacement of hydraulic fluid towards the first chamber of the cylinder, such that the cylinder has a rapid speed upwards movement and the hydraulic fluid in the second chamber of the cylinder is displaced into the tank through the open fourth valve.

This method is advantageous as it “refills” the tank with some of the hydraulic fluid of the second chamber. As the second valve is closed, it is fundamental to guarantee a release of hydraulic fluid when the piston is being pushed up. This is achieved by opening the fourth valve and guaranteeing a displacement of fluid from the second chamber into the tank.

Finally, it is also the aim of the following invention to use, both the inventive system as the inventive method for a pressing machine, a deep drawing machine or similar machines. However as mentioned above, the use of this system is not limited to presses and can be used in whatever process a pump system is required.

Further aspects of the invention are obtained from the following detailed description of one possible embodiment of the invention in conjunction with the drawing and the claims. It is pointed out that modifications or additions as are deduced directly for the person skilled in the art are covered by these examples. Furthermore, the preferred exemplary embodiments do not constitute any restriction of the invention so that modifications and additions also lie within the scope of the present invention.

The accompanying drawings incorporated herein and forming part of the specification, illustrate several aspects of the present invention and together with the description serve to explain certain principles of the invention. In the drawings:

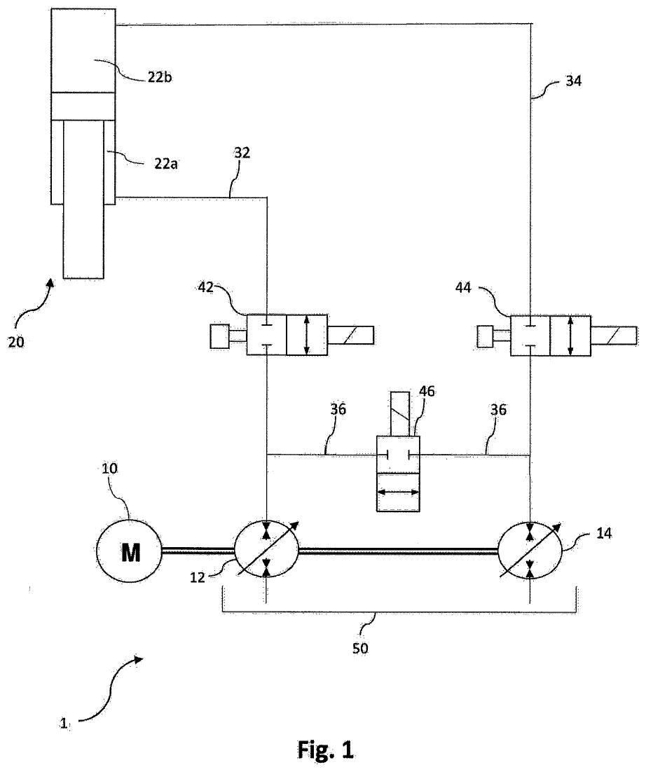

FIG. 1 shows a pump axis control system according to a first embodiment of the current invention;

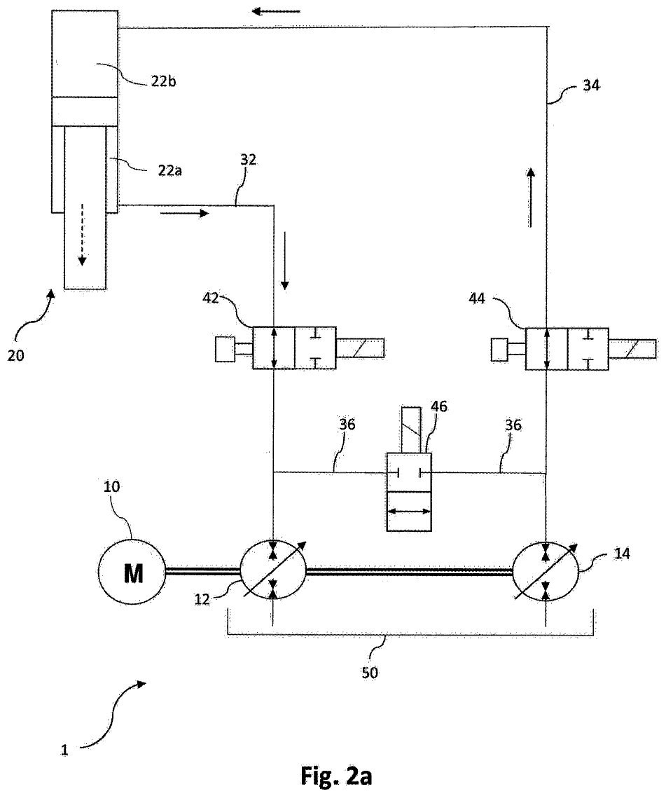

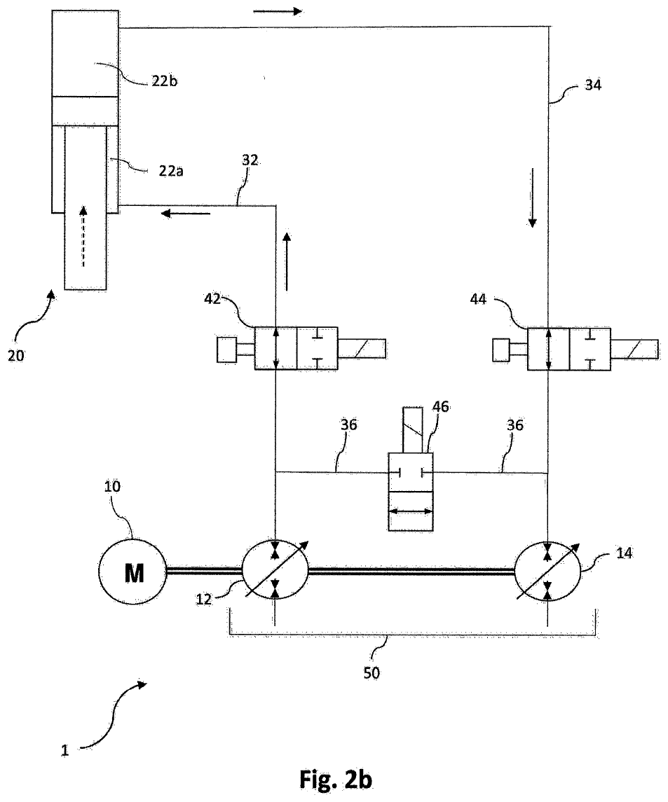

FIG. 2a shows a switch arrangement of the valves for a downwards movement of the system of FIG. 1;

FIG. 2b shows a switch arrangement of the valves for an upwards movement of the system of FIG. 1;

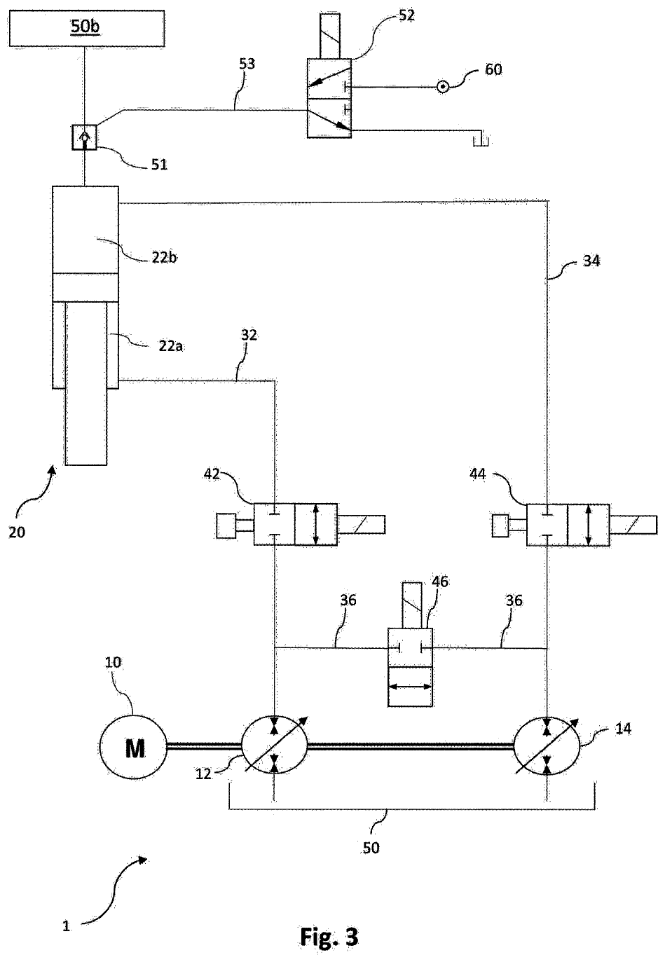

FIG. 3 shows a pump axis control system according to a second embodiment of the current invention, in which a further tank is arranged;

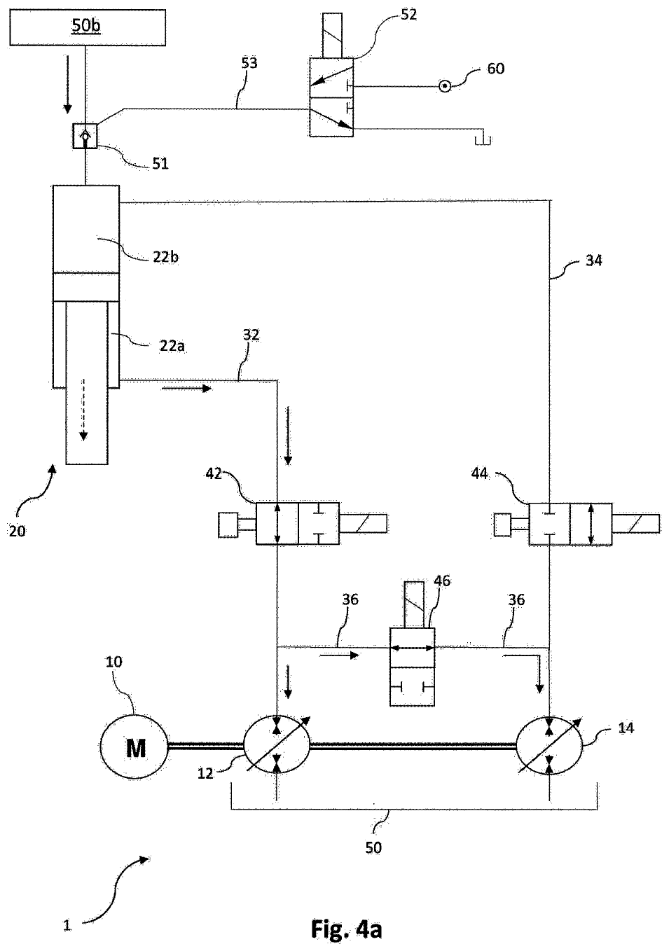

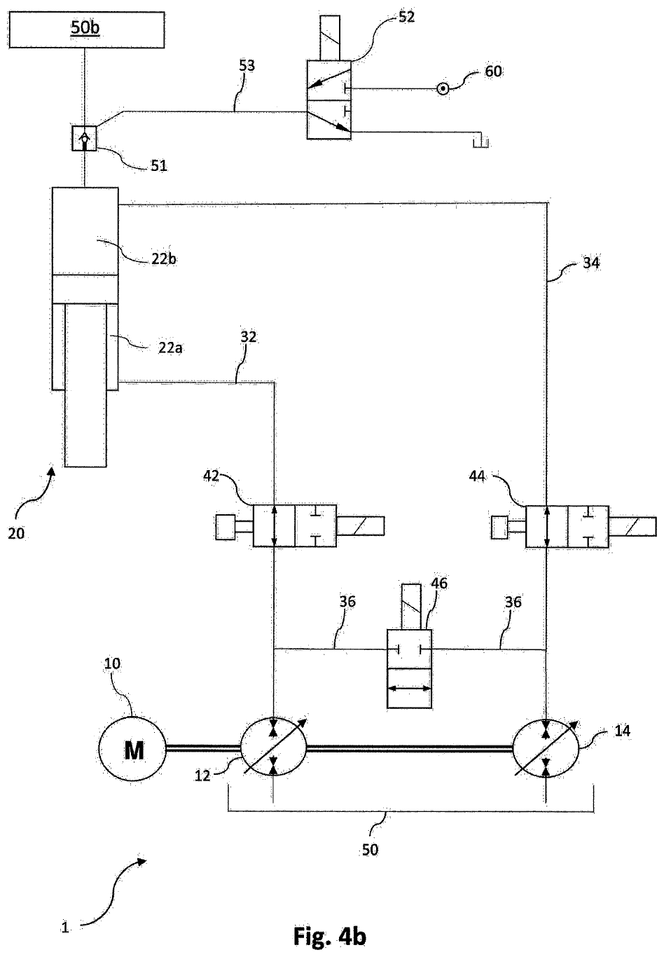

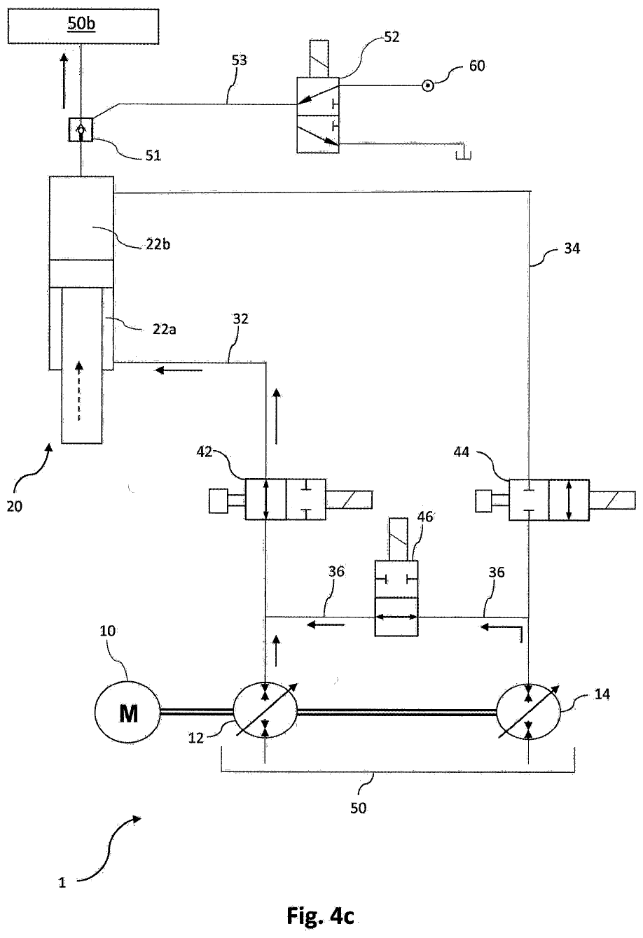

FIG. 4a shows a switching arrangement of the valves for a downwards movement of the system of FIG. 3;

FIG. 4b shows a switching arrangement of the valves for a decompression phase of the system of FIG. 3;

FIG. 4c shows a switching arrangement of the valves for an upwards movement of the system of FIG. 3.

As can be taken from FIG. 1, this embodiment of the system 1 of the current invention has two digital variable displacement pumps, more precisely, a first digital variable displacement pump 12 and a second digital variable displacement pump 14. The first and second pumps 12, 14 are connected in a rotationally locked manner to each other as well as to an electric engine 10. The inlets of the two pumps 12 and 14 are hydraulically connected to an open tank 50 in which relaxed hydraulic fluid is available.

Further, a cylinder 20, which in this embodiment is a differential cylinder 20 having a first chamber 22a which is the rod chamber, and a second chamber 22b, which is the piston chamber, is arranged into the system 1.

The first chamber 22a is hydraulically connected to the first digital variable displacement pump 12 through a first pipeline 32 passing over a controlled 2-way valve 42, having a position monitoring device.

The second chamber 22b is hydraulically connected to the second digital variable displacement pump 14 through a second pipeline 34 passing over a controlled 2-way valve 44, having a position monitoring device.

Between the first valve 42 and the first pump 12 and between the second valve 44 and the second pump 14 a third pipeline 36 connects the first pipeline 32 with the second pipeline 34, passing over a third controlled 2-way valve 46.

In the figure all valves are switched to a closed position. This is a state which nearly never occurs, but has been used here in order to solely describe the arrangement of the various components. In the next figures the various switch position of the valves and the consequence of this switch arrangements are being described more in detail.

FIG. 2a shows the setting of the valves of system 1 of FIG. 1 required to achieve a downwards movement of the cylinder 20. Same referencing numbers are used for the same object as in FIG. 1.

As can be seen the third valve 46 is switched to close, such that the first digital variable displacement pump 12 only works on the first chamber 22a of the cylinder 20, while the second digital variable displacement pump 14 only works on the second chamber 22b of the differential cylinder 20.

In this embodiment, even though the two pumps are connected in a rotationally locked manner with each other, the displacement of hydraulic fluid caused by the pumps is different. The first pump 12 provides a negative displacement drawing hydraulic fluid from the first chamber 22a of the differential cylinder 20 and releasing it into the open tank 50.

The second digital variable displacement pump 14 instead draws hydraulic fluid from the open tank 50, and with a positive displacement pushes it into the second chamber 22b of the differential cylinder 20, providing hence a downwards movement of the piston, as can be taken from the dashed arrow in the figure.

FIG. 2b shows the setting of the valves of system 1 of FIG. 1 required to achieve an upwards movement of the cylinder 20. Same referencing numbers are used for the same object as in FIG. 1.

The embodiment is similar to the one of FIG. 2a and the valves have the same settings as before. The difference is that the first digital variable displacement pump 12 provides a positive displacement of hydraulic fluid from the open tank 50 into the first chamber 22a of the differential cylinder 20, while the second digital variable displacement pump 14 provides a negative displacement of hydraulic fluid from the second chamber 22b of the differential cylinder 20 into the open tank 50. As such, an upwards movement of the cylinder 20 is achieved.

FIG. 3 shows a second embodiment of the system 1 in which the first embodiment depicted in FIG. 1 has been implemented with a further tank 50b. Same referencing numbers are used for the same object as in FIG. 1.

More specifically a tank 50b is hydraulically connected to the second chamber 22b of the differential cylinder 20 trough a fourth valve 51, more precisely a pressure controlled non-return valve 51.

A further pipeline 53 connects the fourth valve 51 with a pressure generator through a pilot valve 52 having a pressurized and a depressurized setting. When the pilot valve is pressurized, pressurized fluid is pushed toward the fourth valve 51 opening it.

In the figure all valves are switched to a closed position. This is a state which nearly never occurs, but has been used here in order to solely describe the arrangement of the various components. In the next figures the various switch position of the valves and the consequence of this switch arrangements are being described more in detail.

FIG. 4a shows a valve switch arrangement in which the cylinder 20 can be moved downwards. As can be taken from the figure, the first and the third valve 42 and 46 are switched to open, while the second valve 44 is switched closed and the pilot valve 52 is depressurized.

Both the first and the second digital variable displacement pump 12 and 14 work in parallel and provide a negative displacement of hydraulic fluid. In this arrangement, the second digital variable displacement pump 14, which usually works on the second chamber 22b of the cylinder 20, works together with the first digital variable displacement pump 12 on the first chamber 22a of the differential cylinder 20.

Therefore, hydraulic fluid is drawn quickly and strongly from the first chamber 22a through the pipeline 32 and the pipeline 36 and through the two pumps 12, 14 into the open tank 50.

In order to have a pressure equilibrium, hydraulic fluid needs to enter chamber 22b contemporaneously. In fact, the pressure of chamber 22b diminishes with the consequence that the fourth valve 51 opens, and hydraulic fluid from the tank 50b flows into the second chamber 22b of the differential cylinder 20.

FIG. 4b shows the embodiment of system 1, according to FIG. 3 in a decompression phase.

This phase starts after the system was running in force speed and the tool was processed. Before decompression the pressure of the hydraulic fluid in the second chamber 22b of the cylinder 20 is very high. Before the cylinder 20 can be, pushed upwards again, a decompression of the hydraulic fluid needs to occur in the second chamber 22b of the cylinder 20.

The decompression is achieved by closing both the third and the fourth valves 46 and 51 while opening both the first and the second valves 42 and 44, without activating the second pump 14.

Due to the high pressure in the second chamber 22b of the cylinder 20, opening the second valve causes a displacement of hydraulic fluid from the second chamber 22b through the second pipeline 34 and through the pump 14 into the open tank 50. This causes a torque movement of the pump 14, which generates energy which can be used contemporaneously as an aid for running the first pump 12, which actively provides a positive displacement into the first chamber 22a. Alternatively the energy can also be saved and reused for further processes.

This embodiment is extremely advantageous as the energy generated by the torque movement of the inactive pump 14, is not lost, but reused for the movement of the first pump 12.

After the decompression a movement of the cylinder in the upwards direction as shown in FIG. 4c can be achieved.

In this embodiment the second valve 44 is closed. The first and third valve 42, 46 are open such that both the first 12 and the second 14 digital variable displacement pump can jointly and parallel work together on the first chamber 22a for the cylinder 20.

The two pumps draw hydraulic fluid from the open tank 50 and displace it into the first chamber 22a of the cylinder 20. The piston is pushed upwards and consequently the hydraulic fluid in the second chamber 22b of the cylinder needs to be released or it over pressurized and can cause a failure of the system as well as severe damages. To achieve this, the valve 52 is pressurized, such that the pressurized fluid runs through the pipeline 53 and causes the fourth valve 51 to open.

In this way, while the piston is being pushed up, the hydraulic fluid from the second chamber 22b of the cylinder 20 can escape into the tank 50b. In this way the tank 50b is refilled and the contained hydraulic fluid can be reused in a further phase.

| | |
|---|---|
| 1 | digital pump axis control system |
| 10 | electric engine |
| 12 | first digital variable displacement |
| | pump |
| 14 | second digital variable |
| | displacement pump |
| 20 | cylinder |
| 22a | first chamber of the cylinder |
| 22b | second chamber of the cylinder |
| 32 | first pipeline |
| 34 | second pipeline |
| 36 | third pipeline |
| 42 | controlled first 2-way valve |
| 44 | second controlled 2-way valve |
| 46 | third controlled 2-way valve |
| 50 | open tank |
| 50b | tank |
| 51 | one-way pressure controlled valve |
| 52 | controlled 3-way valve |
| 53 | pipeline |
| 60 | pressure source |

1. Digital pump axis control system with an at least partially open circuit comprising:
an electric engine connected to power a first hydraulic machine and a second hydraulic machine, wherein the first and second hydraulic machines are connected in a rotationally locked manner to each other;
at least one cylinder having a first chamber and a second chamber, wherein the first chamber of the cylinder is connected through a first pipeline to the first hydraulic machine and the second chamber of the cylinder is connected through a second pipeline to the second hydraulic machine;
a first valve arranged in the first pipeline;
a second valve arranged in the second pipeline;
a third valve arranged in a third pipeline, wherein the third pipeline connects a portion of the first pipeline between the first hydraulic machine and the first valve and connects a portion of the second pipeline between the second hydraulic machine and the second valve; and
an open tank providing hydraulic fluid to inlets of the first and second hydraulic machines, wherein the first and second hydraulic machines are digital variable displacement pumps, each providing a positive and a negative displacement of hydraulic fluid, and wherein the third valve, when open, enables both of the hydraulic machines to work together on the same chamber of the cylinder.

2. The control system according to claim 1, wherein the digital variable displacement pumps provide coordinated displacement of hydraulic fluid when the third valve is open.

3. The control system according to claim 1, wherein the digital variable displacement pumps provide different volume of hydraulic fluid and/or hydraulic fluid with different pressure, into the first pipeline and the second pipeline, respectively.

4. The control system according to claim 1, wherein the digital variable displacement pumps are axial piston pumps, bent axis pumps, variable displacement vane pumps, or radial piston pumps.

5. The control system according to claim 1, wherein the cylinder is a differential cylinder having a rod chamber and a piston chamber.

6. The control system according to claim 1, wherein the cylinder is operable in rapid speed and/or in force speed.

7. The control system according to claim 1, wherein the first and the second valves are controlled 2/2-way valves having a closed state and an open state.

8. The control system according to claim 1, wherein the first and the second valves further comprise a position monitoring device.

9. The control system according to claim 1, wherein the third valve is a controlled 2/2-way valve having a closed state and an open state.

10. The control system according to claim 1, wherein a second tank is hydraulically connected with the second chamber of the cylinder through a fourth valve having an open state and a closed state.

11. The control system according to claim 10, wherein a controlled pilot valve to pilot open the fourth valve is connected through a further pipeline to the fourth valve.

12. The control system according to claim 11, wherein a pressure generator is connected to the controlled pilot valve in order to control the pilot valve through pressurized hydraulic fluid coming from a pressure source.

13. The control system according to claim 11, wherein the pilot valve is a controlled 2/3-way valves having a pressurizing state and a depressurizing state.

14-21. (canceled)

22. A method for controlling operation of an electro-hydrostatic system, comprising:
selecting an electro-hydrostatic system including an electric engine;
powering a first hydraulic machine and a second hydraulic machine with the electric engine, the first and second hydraulic machines being digital variable displacement pumps, each pump providing a positive and a negative displacement of hydraulic fluid, and the pumps being connected in a rotationally locked manner to each other;
wherein the system is selected to include at least a first cylinder having a first chamber and a second chamber, the first chamber being connected through a first pipeline to the first digital variable displacement pump and the second chamber being connected through a second pipeline to the second digital variable displacement pump;
wherein the system is selected to further include a first valve arranged in the first pipeline, a second valve arranged in the second pipeline, and a third valve arranged in a third pipeline, wherein the third pipeline connects a portion of the first pipeline between the first digital variable displacement pump and the first valve and connects a portion of the second pipeline between the second digital variable displacement pump and the second valve;
providing hydraulic fluid from an open tank to inlets of the first and second digital variable displacement pumps; and
operating the third valve, when open, to enable both of the first and second digital variable displacement pumps to work together on the same chamber of the cylinder.

23. The method according to claim 22, wherein:
the third valve is switched to close, and the first and second valves are switched to open;
the first digital variable displacement pump is switched to provide a positive displacement of hydraulic fluid, and
the second digital variable displacement pump is switched to provide a negative displacement of hydraulic fluid, such that an upwards movement of the cylinder is achieved.

24. The method according to claim 22, wherein:
the third valve is switched to close;
the first digital variable displacement pump is switched to provide a negative displacement of hydraulic fluid; and
the second digital variable displacement pump is switched to provide a positive displacement of hydraulic fluid, such that a downwards movement of the cylinder is achieved.

25. The method according to claim 22, wherein:
the first, second and third valves are switched open; and
the first and second digital variable displacement pumps are switched to provide the same displacement of hydraulic fluid towards the second chamber of the first cylinder, such that a low force downwards movement of the first cylinder is achieved.

26. The method according to claim 22, wherein:
a second tank is hydraulically connected with the second chamber of the cylinder through a fourth valve having an open state and a closed state;
a controlled pilot valve to pilot open the fourth valve is connected through a further pipeline to the fourth valve; and
a pressure generator is connected to the controlled pilot valve in order to control the pilot valve through pressurized hydraulic fluid coming from a pressure source.

27. The method according to claim 26, wherein:
the second valve is switched to closed and the pilot valve is switched to the depressurizing state;
the first and third valve are switched open; and
the first and second digital variable displacement pumps are switched to provide the same displacement of hydraulic fluid from the first chamber of the cylinder to the open tank, such that the tank causes a displacement of hydraulic fluid into the second chamber to compensate the volume of hydraulic fluid in the system.

28. The method according to claim 26, wherein
the third valve is switched to closed and the pilot valve is, switched to depressurized state such that the fourth valve is closed;
the first and second valve are switched open;
such that a decompression phase of the cylinder occurs and a displacement of hydraulic fluid from the second chamber to the open tank causes a torque movement of the second digital variable displacement pump through which the engine acts as an energy generator.

29. The method according to claim 26, wherein:
the pilot valve is switched to pressurized state, whereby the fourth valve is opened;
the first and third valves are switched open and the second valve is switched closed; and
the first and second digital variable displacement pumps are switched to provide the same displacement of hydraulic fluid towards the first chamber of the cylinder, such that the cylinder has a rapid speed upwards movement and the hydraulic fluids in the second chamber of the cylinder is displaced into the tank through the open fourth valve.
